(19) United States
(12) Patent Application Publication
(10) Pub. No.: US 2008/0109837 A1
(43) Pub. Date: May 8, 2008

(54) Optical recording medium, information recording or reproducing method, and information recording or reproducing apparatus

(76) Inventors: Joji Anzai, Osaka (JP); Hideki Aikoh, Osaka (JP); Kousei Sano, Osaka (JP); Eishin Mori, Kyoto (JP)

Correspondence Address: WENDEROTH, LIND & PONACK L.L.P., 2033 K. STREET, NW, SUITE 800, WASHINGTON, DC, 20006, US

(21) Appl. No.: 11/907,186

(22) Filed: Oct. 10, 2007

(30) Foreign Application Priority Data
Oct. 10, 2006 (JP) 2006-276498

(51) Int. Cl. G11B 7/24

(52) U.S. Cl. 720/718

(57) ABSTRACT

An optical recording medium improves the quality of servo signals and readout signals by preventing light convergence on the back of the surface of the optical recording medium and reducing interference of light reflected from recording surfaces of the optical recording medium. An optical recording medium 40 includes at least three information recording surfaces, and satisfies d1<(d4−d1), where d1 is a distance from a surface 40z of the optical recording medium 40 to a first information recording surface 40a that is nearest to the surface 40z and d4 is a distance from the surface 40z to a fourth information recording surface 40d that is most distant from the surface 40z, and satisfies dmin≧8 μm, where dmin is a minimum interlayer thickness between the at least three information recording surfaces.

### BACKGROUND OF THE INVENTION

1. Field of the Invention

The present invention relates to an optical recording medium onto which information is recorded or from which information is reproduced by illuminating the optical recording medium with light, and more particularly, to interlayer spacing of an optical recording medium that has four or more information recording surfaces.

2. Description of the Related Art

Optical disks such as DVDs (digital versatile discs) and BDs (blu-ray discs) are high-density, large-capacity optical information recording media, which have been commercialized. Such optical disks have been rapidly widespread in recent years as recording media to record images, music, and computer data. To increase the recording capacity further, an optical disk including a plurality of recording layers has been proposed as described, for example, in Japanese Unexamined Patent Publication No. 2001-155380 (hereafter referred to as Patent Document 1).

FIGS. 12 and 13 show the structures of conventional optical recording media and optical pickups.

The optical recording medium and the optical pickup shown in FIG. 12 will be described first. The optical recording medium 401 shown in FIG. 12 has recording surfaces 401a and 401b. The first recording surface 401a is nearer to a light entering surface of the optical recording medium 401, and is at a distance d1 of 0.075 mm from the light entering surface (the distance d1 corresponds to the thickness of a cover layer). The second recording surface 401b is less near to the light entering surface of the optical recording medium 401, and is at a distance d2 of 0.1 mm from the light entering surface (the distance 2 corresponds to the thickness of the cover layer plus the thickness of an intermediate layer).

Information is recorded onto or reproduced from, for example, the second recording surface 401b in the manner described below.

A light source 1, which is for example a semiconductor laser, emits a linearly-polarized beam 70 having a wavelength λ1 of 405 nm. The beam 70 emitted from the light source 1, which is divergent, passes through a collimating lens 53 having a focal length f1 of 15 mm. The collimating lens 53 includes a spherical aberration correction unit 93. The beam 70 then enters a polarization beam splitter 52. The beam 70 entering the polarization beam splitter 52 passes through the polarization beam splitter 52, and then passes through a quarter-wavelength plate 54. Through the quarter-wavelength plate 54, the beam 70 is converted to a circularly-polarized beam. The beam then passes through an objective lens 56 having a focal length f2 of 2 mm. Through the objective lens 56, the beam is converted to a convergent beam. The beam then passes through a transparent substrate of the optical recording medium 401, and focuses onto the second recording surface 401b. In FIG. 12, the spherical aberration correction unit 93 adjusts the position of the collimating lens 53 to have a spherical aberration of substantially 0 mλ at the second recording surface 401b. The objective lens 56, which has a limited aperture 55, has a numerical aperture NA of 0.85. The beam 70 reflected on the second recording surface 401b passes through the objective lens 56 and the quarter-wavelength plate 54. Through the quarter-wavelength plate 54, the beam is converted to a linearly-polarized beam, which differs from the incoming linearly-polarized beam by 90 degrees. The beam is then reflected by the polarization beam splitter 52. The beam 70 reflected by the polarization beam splitter 52 passes through a collective lens 59 having a focal length f3 of 30 mm. Through the collective lens 59, the beam is converted to a convergent beam. The beam then passes through a cylindrical lens 57 and enters a photodetector 32. The resulting beam 70 has astigmatism, which is produced through the cylindrical lens 57.

The photodetector 32 includes four light receiving units (not shown). Each light receiving unit outputs a current signal determined according to the amount of its received light.

Based on the current signal, a focus error signal (hereafter referred to as an FE signal) is generated using, for example, an astigmatic method, a tracking error signal (hereafter referred to as a TE signal) is generated using a push-pull method, and an information signal (hereafter referred to as an RF signal) recorded on the optical recording medium 401 is generated. The FE and TE signals are amplified with a predetermined gain and then phase-compensated, before supplied to actuators 91 and 92. The FE and TE signals are used to execute focus control and tracking control. To record or reproduce information on the first recording surface 401a, the spherical aberration correction unit 93 adjusts the position of the collimating lens 53 to have a spherical aberration of substantially 0 mλ at the first recording surface 401a.

The optical recording medium and the optical pickup shown in FIG. 13 will now be described. The optical pickup shown in FIG. 13 has substantially the same structure as the optical pickup shown in FIG. 12. A divergent beam 70 emitted from a light source 1 passes through a collimating lens 53 having a focal length f1 of 15 mm. The collimating lens 53 includes a spherical aberration correction unit 93. The beam 70 then enters a polarization beam splitter 52. The beam 70 entering the polarization beam splitter 52 passes through the polarization beam splitter 52, and then passes through a quarter-wavelength plate 54. Through the quarter-wavelength plate 54, the beam 70 is converted to a circularly-polarized beam. The beam then passes through an objective lens 56 having a focal length f2 of 2 mm. Through the objective lens 56, the beam is converted to a convergent beam. The beam then passes through a transparent substrate of the optical recording medium 401, and focuses onto one of recording surfaces 401a, 401b, 401c, and 401d formed in the optical recording medium 401. The objective lens 56 is designed to have a spherical aberration of zero at a depth position of the optical recording medium 401 that is a mean position of the first recording surface 401a and the fourth recording surface 401d. When the beam is to be focused onto any of the recording surfaces 401a to 401d, the spherical aberration correction unit 93 optimizes the position of the collimating lens 53 in the direction of the optical axis to eliminate spherical aberration generated at the recording surfaces 401a to 401d.

The objective lens 56, which has a limited aperture 55, has a numerical aperture NA of 0.85. The beam 70 reflected on the fourth recording surface 401d passes through the objective lens 56 and the quarter-wavelength plate 54. Through the quarter-wavelength plate 54, the beam is converted to a linearly-polarized beam, which differs from the incoming linearly-polarized beam by 90 degrees. The beam is then reflected by the polarization beam splitter 52. The beam 70 reflected by the polarization beam splitter 52 passes through a collective lens 59 having a focal length f3 of 30 mm. Through the collective lens 59, the beam is converted to a convergent beam. The beam then passes through a cylindrical lens 57 and enters a photodetector 32. The resulting beam 70 has astigmatism, which is produced through the cylindrical lens 57.

The photodetector 32 includes four light receiving units (not shown). Each light receiving unit outputs a current signal determined according to the amount of its received light. Based on the current signal, a focus error (FE) signal is generated using an astigmatic method, a tracking error (TE) signal is generated using a push-pull method, and an information (RF) signal recorded on the optical recording medium 401 is generated. The FE and TE signals are amplified with a predetermined gain and then phase-compensated, before supplied to actuators 91 and 92. The FE and TE signals are used to execute focus control and tracking control.

The interlayer thicknesses of the optical recording medium 401 are set at predetermined ratios. More specifically, a thickness t1 from a surface 401z of the optical recording medium 401 to the first recording surface 401a, a thickness t2 from the first recording surface 401a to the second recording surface 401b, a thickness t3 from the second recording surface 401b to the third recording surface 401c, and a thickness t4 from the third recording surface 401c to the fourth recording surface 401d are set at ratios of t1:t2:t3:t4=2:3:4:5. The thicknesses t1 to t4 are not uniform but are at such ratios for the reasons described below.

If the thicknesses t1 to t4 are uniform, the optical recording medium 401 will have the problems described below. When, for example, the beam 70 is focused onto the fourth recording surface 401d to record or reproduce information on the fourth recording surface 401d, the beam 70 is partially reflected on the third recording surface 401c. The distance from the third recording surface 401c to the fourth recording surface 401d is the same as the distance from the third recording surface 401c to the second recording surface 401b. In this case, the part of the beam 70 reflected on the third recording surface 401c converges on the back of the second recording surface 401b. The beam is then reflected on the second recording surface 401b and is reflected again on the third recording surface 401c. The reflected beam mixes with light reflected from the fourth recording surface 401d, from which information is to be read. The distance from the second recording surface 401b to the fourth recording surface 401d is also the same as the distance from the second recording surface 401b to the surface 401z of the optical recording medium 401. In this case, the beam 70 is partially reflected on the second recording surface 401b. The part of the beam 70 reflected on the second recording surface 401b converges on the back of the surface 401z of the optical recording medium 401. The beam is then reflected on the surface 401z and is reflected again on the second recording surface 401b. The reflected beam mixes with light reflected from the fourth recording surface 401d, from which information is to be read. In this manner, the reflected light converging on the backs of the other surfaces overlays the light reflected from the fourth recording surface 401d, from which information is to be read. Such interference of light will disturb correct recording or reproducing on the fourth recording surface 401d.

To solve this problem, one method sets the distances between the recording surfaces of the optical recording medium 401 in a manner that recording surfaces have a smaller interlayer distance between adjacent recording surfaces as they are nearer to the surface 401z of the optical recording medium 401 (see Patent Document 1). This method prevents the beam 70 from converging, for example, on the back of the second recording surface 401b or on the back of the surface 401z when the beam 70 is focused onto the fourth recording surface 401d to read information from the fourth recording surface 401d. Here, the thicknesses t1 to t4 each have a manufacturing error of ±10 μm. The thicknesses t1 to t4 need to differ from one another even when the thicknesses t1 to t4 each vary within the manufacturing error. To set the thicknesses t1 and t4 at different values after considering such a manufacturing error, the thicknesses t1 to t4 may be set at values that differ from one another by 20 μm. More specifically, the thickness t1 is set at 40 μm, the thickness t2 at 60 μm, the thickness t3 at 80 μm, and the thickness t4 at 100 μm. In this case, a total interlayer thickness t (=t2+t3+t4), which is a total of the interlayer thicknesses between the first recording surface 401a to the fourth recording surface 401d, is 240 μm.

To increase the recording capacity further, the optical recording medium may be designed to have more recording surfaces. In this case, the interlayer distances of some of the recording surfaces (the distances between some of the recording surfaces) of the optical recording medium may coincide with one another when the interlayer distances vary. When signals are to be read from one recording surface of this optical recording medium, interference of light from other recording surfaces may disturb stable reading of signals from the recording surface. When, for example, the optical disk has four recording surfaces and signals are to be read from the fourth recording surface, the optical pickup is controlled to focus a beam on the fourth recording surface through focus control. However, the beam is partially reflected on the third recording surface and the reflected part of the beam converges on the second recording surface. The beam converging on the second recording surface is reflected on the second recording surface and is reflected again on the third recording surface. The beam then travels on the same optical path as the beam reflected on the fourth recording surface, and then enters the detector of the optical pickup. The beam reflected on the second recording surface causes crosstalk, which disturbs correct reading of signals on the fourth recording surfaces. This problem is referred to as the “back-surface convergence problem” in this specification.

To solve this problem, the structure of the optical disk described in Patent Document spaces the recording layers of the optical disk. In detail, assuming one of the recording layers as a reference, the structure sets the distance between the reference recording layer and each of all recording layers that are nearer to the support substrate than the reference recording layer to differ from the distance between the reference recording layer and each of all recording layers that are nearer to the cover layer than the reference recording layer.

One embodiment of this structure sets the thicknesses of the intermediate layers in a manner that intermediate layers have greater thicknesses as they are nearer to the cover layer and less near to the support substrate, or that intermediate layers have smaller thicknesses as they are nearer to the cover layer and less near to the support substrate.

However, the disk structure described in Patent Document 1 only intends to solve the problem of interlayer crosstalk, which increases as illumination light from the optical head converges on other layers during readout of one layer. This disk structure fails to solve the problem of interference between the reflected light of the readout layer and the reflected light from other layers and from the surface of the optical recording medium.

FIG. 14 is a cross-sectional view of a three-layer disk 40 with a conventional disk structure. The disk 40 includes recording layers (surfaces) 101 to 103, a cover layer 105, and intermediate layers 106 and 107 as shown in the figure.

With the disk structure shown in FIG. 14, for example, light is reflected on the other layer (the second recording layer 102 in this example) that is not the readout layer (the third recording layer 103 in this example), and part of the reflected light travels on the same optical path as reflected light 108 from the readout layer, and returns to the optical head with substantially the same wavefront as the reflected light 108. The light reflected from the other layer is coherent with the reflected light 108, and forms bright and dark interference fringes on the light receiving units. Here, the phase difference between the reflected light 108 and the light reflected from the other layer may change when the thicknesses of the intermediate layers of the optical disk vary only slightly. The interference fringes formed by the coherent light may change accordingly when the phase difference changes. This may greatly lower the quality of servo signals and readout signals.

The problem of interference described above is not only limited to the disk structure described in Patent Document 1 that intends to solve the back-surface convergence problem.

FIG. 15 is a cross-sectional view of a four-layer disk 40 that is structured to avoid the back-surface convergence problem, which is to be solved by the structure in Patent Document 1. The disk 40 includes recording layers (surfaces) 111 to 114, a cover layer 115, and intermediate layers 116 to 118 as shown in the figure.

In this structure, the thicknesses of the cover layer 115 and the intermediate layers 116 and 117 are set to differ from one another. This structure prevents light convergence from occurring on the backs of the information recording surfaces.

However, when the thickness of the cover layer, which corresponds to the distance from the surface of the disk 40 to the first recording layer 111, is equal to the distance from the fourth recording layer 114 to the first recording layer 111, light 108 reflected on the fourth recording layer 114 converges on the back of the surface of the disk 40 and is reflected on the surface of the disk 40. The light 108 is reflected again on the fourth recording layer 114, and is then guided to the light receiving units. Unlike a light flux that converges on the back of a recording layer that is not a readout layer, the light flux that converges on the back of the surface of the disk 40 does not carry information including as pits and marks. However, when the disk 40 is designed to have more recording layers, a light flux that converges on the back of the disk surface can be as large as a light flux that converges on the back of a recording layer that is not a readout layer. In this case, even the light flux that converges on the back of the disk surface will interfere with a light flux reflected from the readout layer, just like the light flux that converges on the back of the other recording layer interferes with the light flux reflected from the readout layer. As a result, this structure may greatly lower the quality of servo signals and readout signals.

Further, not only interference of light associated with the back-surface convergence but also interference of light associated with other factors may greatly lower the quality of servo signals and readout signals. When, for example, information is recorded or reproduced on the second recoding layer 112, light reflected from the first recording layer 111 and the third recording layer 113, which are adjacent to the second recording layer 112, also enters the light receiving units. If the distance between the second recording layer 112 and the first recording layer 111 or the distance between the second recording layer 112 and the third recording layer 113 is not sufficiently large, the reflected light from the first or third recording layers 111 and 113 may interfere with the light flux reflected from the second recording layer 112. This may greatly lower the quality of readout signals.

### SUMMARY OF THE INVENTION

It is an object of the present invention to improve the quality of servo signals and readout signals of an optical recording medium by preventing light convergence on the back of the surface of the optical recording medium and reducing interference of light reflected from recording surfaces of the optical recording medium.

A first aspect of the present invention provides an optical recording medium having at least three information recording surfaces, wherein d1<(dm−d1), where d1 is a distance from a surface of the optical recording medium to one of the at least three information recording surfaces that is nearest to the surface of the optical recording medium and dm is a distance from the surface of the optical recording medium to one of the at least three information recording surfaces that is most distant from the surface of the optical recording medium, and dmin≧8 μm, where dmin is a minimum interlayer thickness between the at least three information recording surfaces.

Because d1≠(dm−d1), light convergence is less likely to occur on the back of the surface of the optical recording medium. Further, because d1<(dm−d1), the cover layer is thin. This increases permissible errors of the thicknesses of the intermediate layers. Further, because dmin>8 μm, interference of light reflected from adjacent recording surfaces is less likely to occur. This structure consequently improves the quality of servo signals and readout signals.

It is preferable that d1 is smaller than (dm−d1) by at least 1 μm.

It is preferable that d1≧38 μm. The cover layer having a sufficiently large thickness will prevent flaws and dust on the disk surface from significantly affecting the quality of signals.

It is preferable that d1<47 μm.

Further, it is preferable that one of the at least three information recording surfaces that is the third nearest to the surface of the optical recording medium or one of the at least three information recording surfaces that is more distant from the surface of the optical recording medium than the third nearest information recording surface is at a distance of 100 μm from the surface of the optical recording medium.

Moreover, it is preferable that the at least three information recording surfaces consist of four information recording surfaces.

Moreover, it is preferable that one of the four information recording surfaces that is the fourth nearest to the surface of the optical recording medium is at a distance of 100 μm from the surface of the optical recording medium.

Another aspect of the present invention provides an optical recording medium having four information recording surfaces. The four information recording surfaces consist of a first information recording surface, a second information recording surface, a third information recording surface, and a fourth information recording surface that are arranged sequentially in a stated order from a surface side of the optical recording medium. The first information recording surface is at a distance of 47 μm or less from a surface of the optical recording medium. A thickness of an intermediate layer arranged between the first information recording surface and the second information recording surface falls within one of a range of 11 to 15 μm, a range of 16 to 21 μm, and a range of 22 μm or greater. A thickness of an intermediate layer arranged between the second information recording surface and the third information recording surface falls within another one of the ranges. A thickness of an intermediate layer arranged between the third information recording surface and the fourth information recording surface falls within still another one of the ranges. The fourth information recording surface is at a distance of 100 μm from the surface of the optical recording medium.

The first information recording surface has a distance of 47 μm or less from the surface of the optical recording medium and the fourth information recording surface is at a distance of 100 μm from the surface of the optical recording medium. Thus, light convergence is less likely to occur on the back of the surface of the optical recording medium. Further, because the thickness of each of all the intermediate layers is 11 μm or greater, interference of light reflected from adjacent recording surfaces is less likely to occur. This structure improves the quality of servo signals and readout signals.

The optical recording medium of the present invention improves the quality of servo signals and readout signals by preventing light convergence on the back of its surface and reducing interference of light reflected from its recording surfaces.

### BRIEF DESCRIPTION OF THE DRAWINGS

FIG. 1 shows the structure of an optical information apparatus of the present invention;

FIG. 2 schematically shows the structure of an optical recording medium and of an optical pickup of the present invention;

FIG. 3 shows the layer structure of the optical recording medium of the present invention;

FIG. 4 shows light reflected from an information recording surface on which recording and reproduction is performed, and describes one problem to be solved by the present invention;

FIG. 5 shows light reflected from information recording surfaces other than the information recording surface on which recording and reproduction is performed, and describes the problem to be solved by the present invention;

FIG. 6 shows light reflected from information recording surfaces other than the information recording surface on which recording and reproduction is performed, and describes the problem to be solved by the present invention;

FIG. 7 shows light reflected from information recording surfaces other than the information recording surface on which recording and reproduction is performed, and describes the problem to be solved by the present invention;

FIG. 8 shows the relationship between the amplitude of an FS signal and a difference in the interlayer thicknesses of the optical recording medium;

FIG. 9 shows the relationship between the base material thickness difference of the optical recording medium and the value of jitter;

FIG. 10 shows the relationship between the cover layer thickness of the optical recording medium and the maximum permissible manufacturing error of intermediate layers;

FIG. 11 shows the relationship between the cover layer thickness of the optical recording medium and the error rate;

FIG. 12 shows the structure of an optical recording medium and of an optical pickup head apparatus included in a conventional optical information apparatus;

FIG. 13 shows the structure of an optical recording medium and of an optical pickup head apparatus included in another conventional optical information apparatus;

FIG. 14 is a cross-sectional view of one conventional disk structure showing a path of reflected light; and

FIG. 15 is a cross-sectional view of another conventional disk structure showing a path of reflected light.

### DETAILED DESCRIPTION OF THE INVENTION

An optical recording medium, an optical information apparatus, an optical pickup head apparatus, and an optical information reproducing method of the present invention will now be described with reference to the drawings. In the drawings, the same components and the same functions or operations are given the same reference numerals.

### First Embodiment

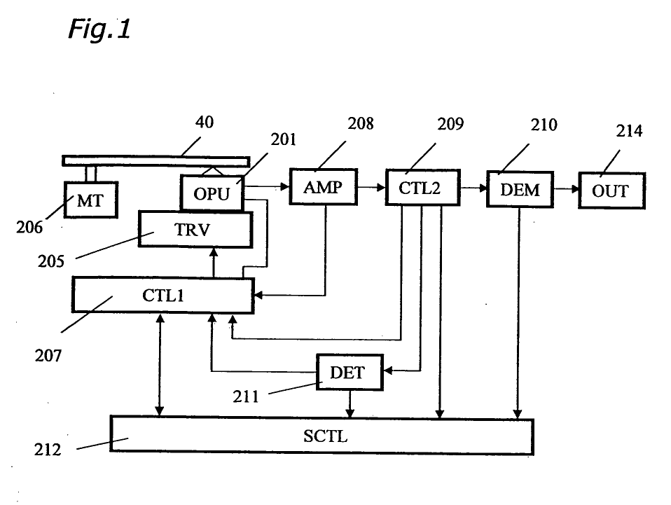

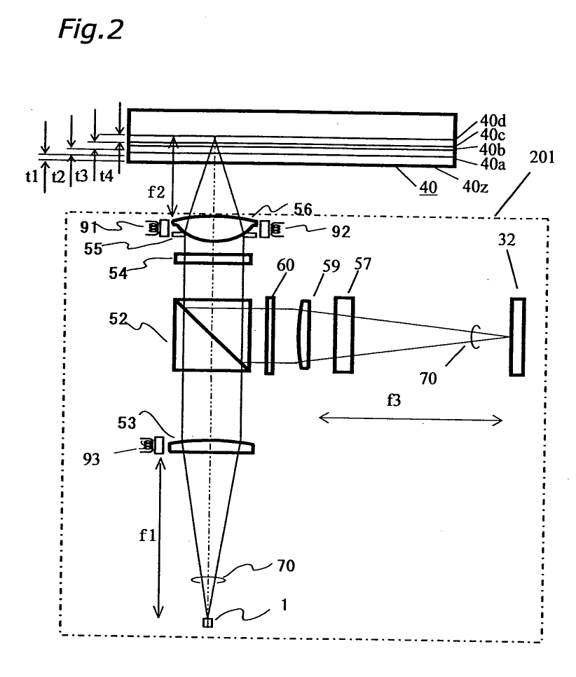

An embodiment of the present invention will now be described with reference to FIGS. 1 and 2.

FIG. 1 shows the structure of an optical information apparatus according to the embodiment of the present invention. An optical pickup head apparatus 201 (also referred to as an optical pickup) illuminates an optical recording medium 40 with a laser beam having a wavelength λ of 405 nm, and reproduces signals recorded on the optical recording medium 40. A pickup-movement controller 205 moves the optical pickup head apparatus 201 in the radial direction of the optical recording medium 40 to record or reproduce information at a desired position on the optical recording medium 40. A motor 206 drives the optical recording medium 40 and rotates the optical recording medium 40. A controller 207 controls the optical pickup head apparatus 201, the pickup-movement controller 205, and the motor 206.

An amplifier 208 amplifies a signal that is read by the optical pickup head apparatus 201, and outputs the amplified signal. The output signal of the amplifier 208 is input into a controller 209. The controller 209 generates servo signals including FE and TE signals based on the input signal, and outputs the servo signals to the controller 207. The servo signals will be used by the optical pickup head apparatus 201 to read signals from the optical recording medium 40. The controller 209 digitizes (binarizes) the input analogue signal. A demodulator 210 analyzes the signal that has been read from the optical recording medium 40 and has been digitized, and reconstructs the original data such as video and music. An output unit 214 outputs the reconstructed signal.

A detector 211 detects an address signal or the like based on the signals output from the controller 209, and outputs the detected signal to a system controller 212. The system controller 212 reads physical format information and optical recording medium manufacturing information (optical recording medium management information) from the optical recording medium 40 and identifies the optical recording medium 40 based on the read information. The system controller 212 then decodes, for example, the conditions for recording and reproduction, and controls the entire optical information apparatus. To record or reproduce information on the optical recording medium 40, the controller 207 drives and moves the pickup-movement controller 205 according to an instruction provided from the system controller 212. More specifically, the pickup-movement controller 205 moves the optical pickup head apparatus 201 to a desired position on a second information recording surface 40b of the optical recording medium 40, which will be described later with reference to FIG. 2. As a result, the optical pickup head apparatus 201 records or reproduces information on the information recording surface of the optical recording medium 40.

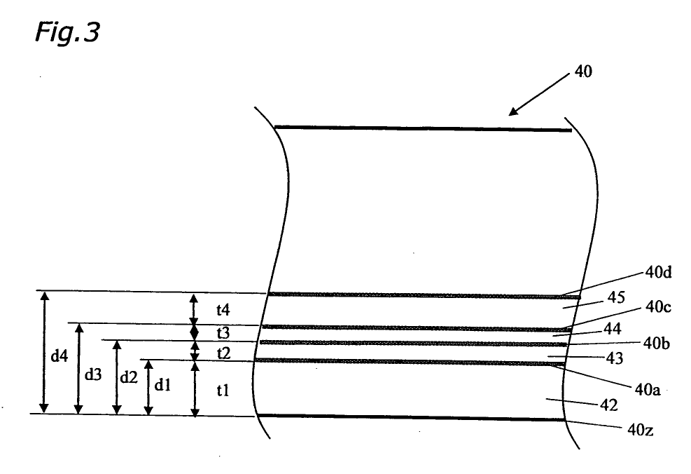

FIG. 2 shows one example of the structure of the optical recording medium 40 and of the optical pickup head apparatus 201 according to the embodiment of the present invention. The optical recording medium 40 includes four information recording surfaces. More specifically, the optical recording medium 40 includes information recording surfaces 40a, 40b, 40c, and 40d, which are arranged sequentially in the stated order from the surface side of the optical recording medium 40 as shown in FIG. 3. The optical recording medium 40 further includes a cover layer 42, a first intermediate layer 43, a second intermediate layer 44, and a third intermediate layer 45. The cover layer 42 (a base material placed between a surface 40z and the first information recording surface 40a) has a thickness t1. The first intermediate layer 43 (a base material placed between the first information recording surface 40a and the second information recording surface 40b) has a thickness t2. The second intermediate layer 44 (a base material placed between the second information recording surface 40b and the third information recording surface 40c) has a thickness of t3. The third intermediate layer 45 (a base material placed between the third information recording surface 40c and the fourth information recording surface 40d) has a thickness t4. The surface 40z and the first information recording surface 40a have a distance d1 (≈t1) between them. The surface 40z and the second information recording surface 40b have a distance d2 (≈t1+t2) between them. The surface 40z and the third information recording surface 40c have a distance d3 (≈t1+t2+t3) between them. The surface 40z and the fourth information recording surface 40d have a distance d4 (≈t1+t2+t3+t4) between them.

Information is recorded onto or reproduced from, for example, the fourth information recording surface 40d in the manner described below.

A light source 1 emits a linearly-polarized divergent beam 70 having a wavelength λ of 405 nm. The beam 70 emitted from the light source 1 is collimated through a collimating lens 53 having a focal length f1 of 18 mm. The collimated beam then passes through a polarization beam splitter 52, and then passes through a quarter-wavelength plate 54. Through the quarter-wavelength plate 54, the beam is converted to a circularly-polarized beam. The beam then passes through an objective lens 56 having a focal length f2 of 2 mm. Through the objective lens 56, the beam is converted to a convergent beam. The beam then passes through the cover layer 42 of the optical recording medium 40, and focuses onto the fourth recording surface 40d. The objective lens 56, which has a limited aperture 55, has a numerical aperture NA of 0.85. Further, a spherical aberration correction unit 93, which is formed by a stepping motor or the like, adjusts the position of the collimating lens 53 in the direction of the optical axis to have a spherical aberration of substantially 0 mλ at the fourth information recording surface 40d.

The beam 70 reflected on the fourth recording surface 40d passes through the objective lens 56 and the quarter-wavelength plate 54. Through the quarter-wavelength plate 54, the beam is converted to a linearly-polarized beam, which differs from the incoming linearly-polarized beam by 90 degrees. The beam is then reflected by the polarization beam splitter 52. The beam 70 reflected by the polarization beam splitter 52 is split into a zeroth-order beam 70 and a first-order beam by a diffraction grating 60, which functions as a beam splitter element. The beam then passes through a collective lens 59 having a focal length f3 of 30 mm and a cylindrical lens 57, and enters a photodetector 32. The beam 70 entering the photodetector 32 has astigmatism, which is produced through the cylindrical lens 57.

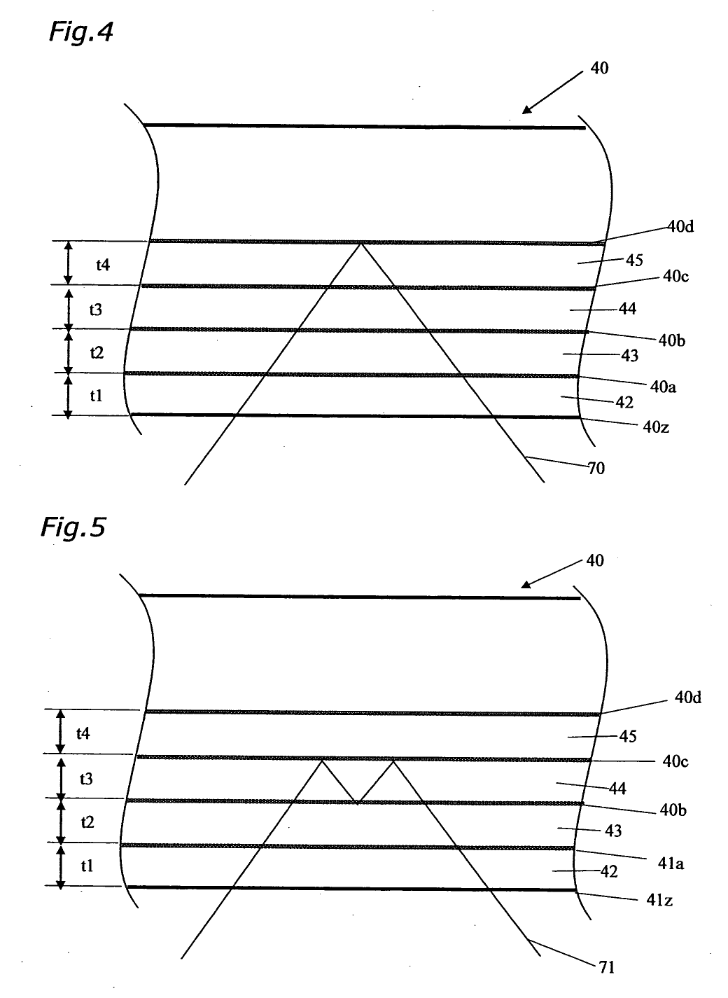

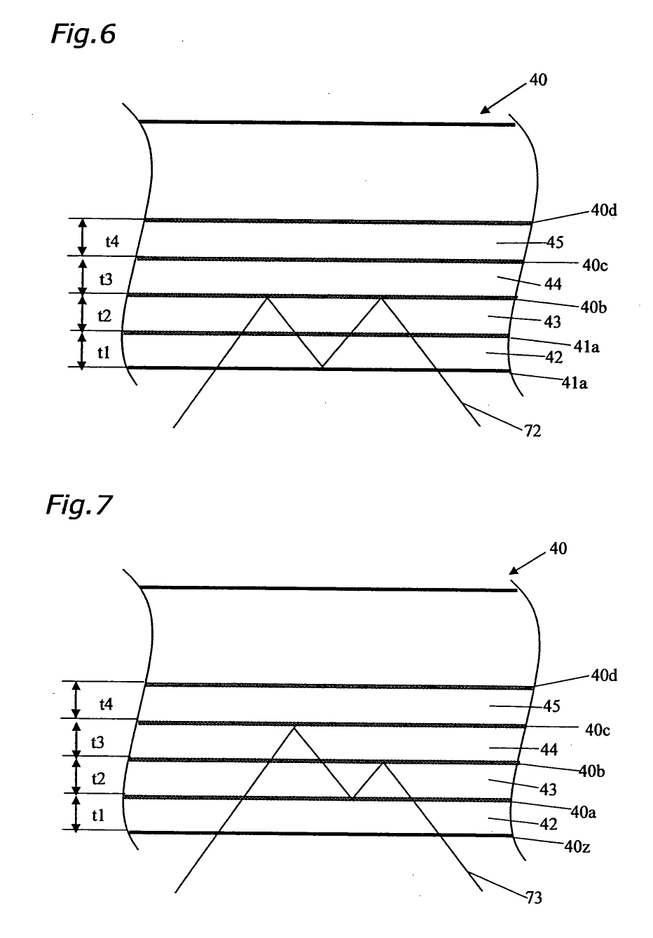

The optical recording medium that has four information recording surfaces have problems to be solved. The first problem is interference of light reflected from multiple surfaces. The first problem, that is, the interference of reflected light, will be described with reference to FIGS. 4 to 7. The light flux focused for reproduction or recording as shown in FIG. 4 includes the beams listed below.
The beam 70 shown in FIG. 4, which is focused on the readout or recording surface.
The beam 71 shown in FIG. 5, which is reflected on the third information recording surface 40c, converges on the second information recording surface 40b and is reflected on the second information recording surface 40b, and then is reflected again on the third information recording surface 40c.
The beam 72 (back-surface converging beam) shown in FIG. 6, which is reflected on the second information recording surface 40b, converges on the surface of the optical recording medium and is reflected on the surface of the optical recording medium, and then is reflected again on the second information recording surface 40b.
The beam 73 shown in FIG. 7, which is reflected on the information recording surfaces 40c, 40a, and 40b sequentially in the stated order without converging on the information recording surfaces.

Here, when t4=t3, the beam 70 and the beam 71 enter the photodetector 32 with the same light flux diameter after traveling on the optical paths with the same length. In the same manner, the beam 70 and the beam 72 enter the photodetector 32 with the same light flux diameter after traveling on the optical paths with the same length when t4=t2, and the beam 70 and the beam 73 enter the photodetector 32 with the same light flux diameter after traveling on the optical paths with the same length when t1+t2=t3+t4. The beams 71 to 72, which are reflected on multiple surfaces, have smaller light amounts than the beam 70. However, the beams 71 to 72, which enter the photodetector 32 with the same light flux diameter after traveling on the optical paths with the same length, interfere significantly with the beam 70. Further, the amount of light received by the photodetector 32 changes greatly when the interlayer thicknesses of the optical recording medium 40 vary only slightly. As a result, the photodetector 32 may fail to detect signals in a stable manner.

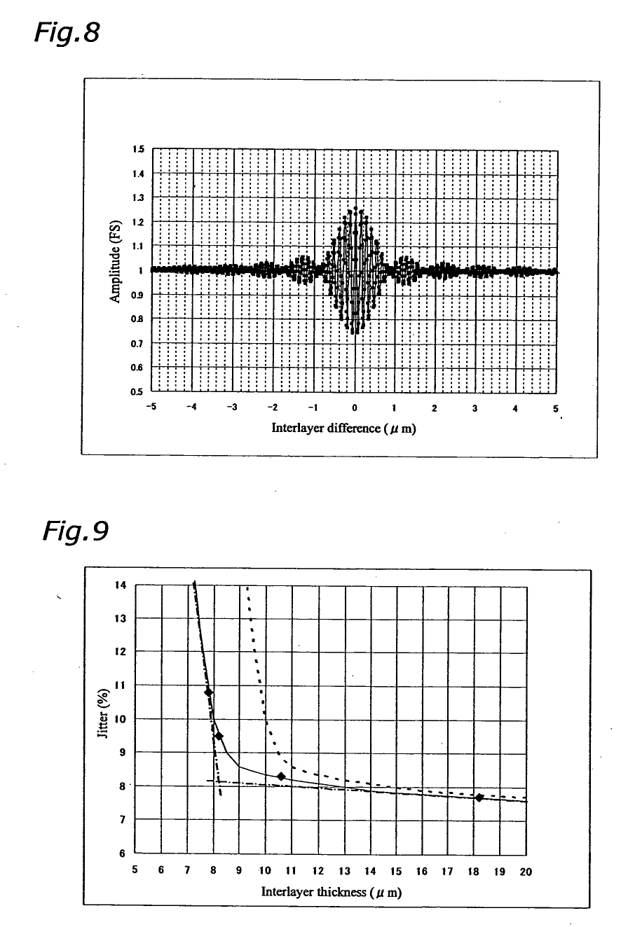

FIG. 8 shows the amplitude of an FS signal as a function of a difference in the interlayer thicknesses of the optical recording medium 40 when the ratio of the amount of the beam 70 to the amount of the beam 71, to the amount of the beam 72, or to the amount of the beam 73 is 100:1 and the refractive index of the cover layer 42 and the first intermediate layer 43 is 1.57. The horizontal axis indicates the interlayer thickness difference, whereas the vertical axis indicates the amplitude of the FS signal. The FS signal is expressed as values standardized using the DC amount of reflected light of only the beam 70 that is received by the photodetector 32. As shown in FIG. 8, the amplitude of the FS signal changes drastically when the interlayer thickness difference is ±11 μm and less.

The second problem of the optical recording medium that has four information recording surfaces is crosstalk between adjacent information recording surfaces, which occurs when the interlayer distance between the information recording surfaces is extremely small. The adjacent information recording surfaces need to have at least a predetermined distance between them to reduce crosstalk. To determine a minimum interlayer thickness, various interlayer thicknesses of optical recording media have been examined. FIG. 9 shows the relationship between the interlayer thickness of the disk and the value of jitter generated in the disk. The recording layers of the disk have substantially the same refractivity. In FIG. 9, the horizontal axis indicates the interlayer thickness, whereas the vertical axis indicates the value of jitter generated when information is recorded randomly on the recording layers of 25 GB. The results indicate that the value of jitter increases more as the interlayer thickness is thinner. The graph representing the jitter value has a point of inflection when the interlayer thickness is about 8 μm. The jitter value increases drastically when the interlayer thickness is 8 μm and less.

The structure of the optical recording medium 40 of the embodiment will now be described with reference to FIG. 3. In the present embodiment, the optical recording medium 40 is structured to satisfy conditions (1) to (4) described below to solve the first problem. The structure of the optical recording medium 40 is structured to satisfy the conditions (1) to (4) after considering manufacturing errors of its interlayer thicknesses.

Condition 1: The thickness t1 of the cover layer 42 and each of the thicknesses t2 to t4 of the intermediate layers 43 to 45 differ from each other by at least 1 μm.

Condition 2: The thickness t1 of the cover layer 42 and the total thickness of the intermediate layers 43 to 45 (t2+t3+t4) differ from one another by at least 1 μm.

Here, condition 2 will be described in detail. The thickness t1 of the cover layer 42 differing from the total thickness of the intermediate layers 43 to 45 (t2+t3+t4) is equivalent to d1≠(d4−d1), or more specifically, to d1<(d4−d1). Here, d1 is a distance from the surface 40z of the optical recording medium 40 to the first information recording surface 40a, which is nearest to the surface 40z, and d4 is a distance from the surface 40z to the fourth information recording surface 40d, which is most distant from the surface 40z. Since d1≠(d4−d1), light convergence is less likely to occur on the back of the surface 40z. In addition, since d1<(dm−d1), the cover layer 42 is thin. This increases permissible errors of the thicknesses of the intermediate layers 43 to 45. Further, since dmin≧8 μm, interference of light reflected from adjacent recording surfaces is less likely to occur. This structure consequently improves the quality of servo signals and readout signals.

Condition 3: The thickness t1 of the cover layer 42 and the total thickness (t2+t3) of the thickness t2 of the first intermediate layer 43 and the thickness t3 of the second intermediate layer 44 differ from each other by at least 1 μm.

Condition 4: The total thickness (t1+t2) of the thickness t1 of the cover layer 42 and the thickness t2 of the first intermediate layer 43 and the total thickness (t3+t4) of the thickness t3 of the second intermediate layer 44 and the thickness t4 of the third intermediate layer 45 differ from each other by at least 1 μm.

The optical recording medium 40 further satisfies condition (5) described below to solve the second problem.

Condition 5: The minimum interlayer thickness dmin is 8 μm or greater, or preferably 10 μm or greater.

Condition 5 is necessary because the recording layers of the disk can often differ from one another in refractivity due to conditions for manufacturing disks. In detail, the refractivity of one recording layer may be 1.5 times the refractivity of another recording layer. When, for example, the refractivity of one layer is 1.5 times the refractivity of the readout layer or of the recording layer, interference between light from the layer with the higher refractivity and the readout layer will affect readout by a degree √ 1.5 times the degree by which such interference can affect readout layer when these layers have the same refractivity. In this case, the graph representing the value of jitter as a function of the interlayer thickness is changed to the graph indicated by a broken line in FIG. 9. When the minimum interlayer thickness dmin is set at 8 μm or greater, or preferably 10 μm or greater, the density of stray light coming from the other layer and received in the light receiving units will be 1.5 (refractivity)*( 8/10)²=0.96. This will offset the increased reflection efficiency of the other layer. The minimum interlayer thickness dmin is 8 μm or greater. This value corresponds to the inflection point of the value of jitter generated in the optical recording medium when the recording layers of the optical recording medium have the same refractivity as shown in FIG. 9.

In the present embodiment, the fourth information recording surface 40d, which is most distant from the surface 40z, is at a distance of substantially 100 μm from the surface 40z. The optical recording medium with this structure is advantageous in that the optical recording medium is compatible with BDs (blu-ray discs), which have the largest capacity of all the optical disks that are available at the present, and in that the optical recording medium has sufficiently large system margins including tilt margins.

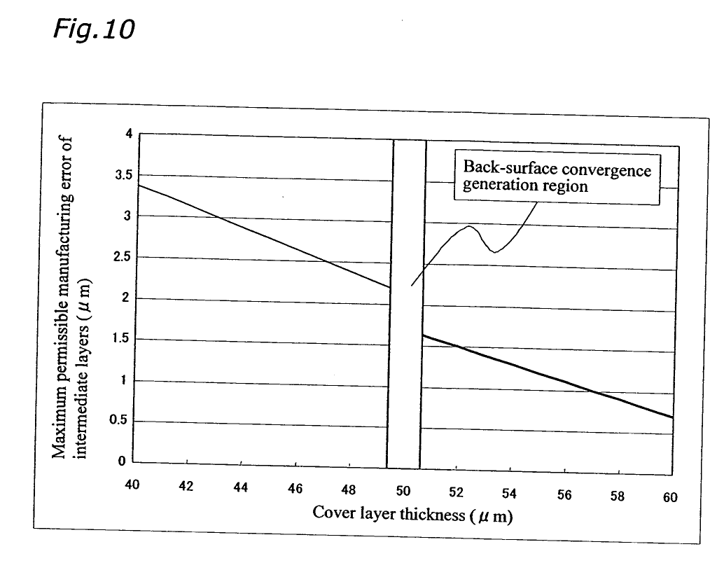

When the cover layer 42 and the intermediate layers 43 to 45 each have a manufacturing margin of ±e μm, the interlayer thicknesses t2 to t4 that satisfy the conditions described above have center values of any combination of 10+e (μm), 10+3e+1 (μm), and 10+5e+2 (μm). FIG. 10 shows the relationship between the cover layer thickness t1 that satisfies the conditions described above and the maximum permissible manufacturing error e (μm) of each of the intermediate layers 43 to 45. The shaded region in the figure indicates the thickness t1 of the cover layer in a range of 49.5 to 51.5 μm. Based on condition 2, the back-surface convergence problem occurs when the thickness t1 of the cover layer is in this range. Thus, the thickness t1 of the cover layer needs to be set out of this range. Further, when the thickness t1 of the cover layer 42 is 49.5 μm or less, the distance from the surface 40z to the fourth information recording surface 40d, which is most distant from the surface 40z, is 100 μm. In this case,

$$\begin{matrix}100 = t 1 + t 2 + t 3 + t 4 \\ = t 1 + 10 + e + 10 + 3 e + 1 + 10 + 5 e + 2.\end{matrix} \qquad ( 1 )$$

However, when the thickness t1 of the cover layer 42 is 49.5 μm or less, meaning that the maximum thickness of the cover layer 42 needs to be 49.5 μm or less after considering the manufacturing error e μm,

$$\begin{matrix}100 = ( t 1 - e ) + 10 + e + 10 + 3 e + 1 + 10 + 5 e + 2 e \\ = ( 67 - d 1 ) / 8.\end{matrix}$$

Further, when the thickness t1 of the cover layer 42 is 50.5 μm or greater, meaning that the minimum thickness of the cover layer 42 needs to be 50.5 μm or greater,

$$\begin{matrix}100 = ( t 1 + e ) + 10 + e + 10 + 3 e + 1 + 10 + 5 e + 2 e \\ = ( 67 - t 1 ) / 10.\end{matrix}$$

As a result, the graph representing the permissible interlayer thickness error e has discontinuous values because of the excluded region of the thickness t1 of the cover layer 42 as indicated by a solid line in FIG. 10. The permissible interlayer thickness error e is greater when the interlayer thickness is 49.5 μm or less.

In other words, the permissive interlayer thickness error is greater when
d1≦(100−d1)−1 (μm).

The disk that satisfies this condition has greater permissive manufacturing errors. Thus, the disk that satisfies this condition will be manufactured at a lower cost.

In the present embodiment, when the thickness t1 of the cover layer 42 is 50 μm or greater, the maximum permissible interlayer thickness error is as small as 1.6 μm or less. In this case, the disk requires an extremely high precision during manufacturing. This may increase the cost of the disk.

The above finding indicates that the permissible interlayer thickness errors increase as the thickness t1 of the cover layer 42 is thinner. However, the cover layer that is too thin will lower the quality of signals when flaws are formed on the disk surface or dust is adhered on the disk surface.

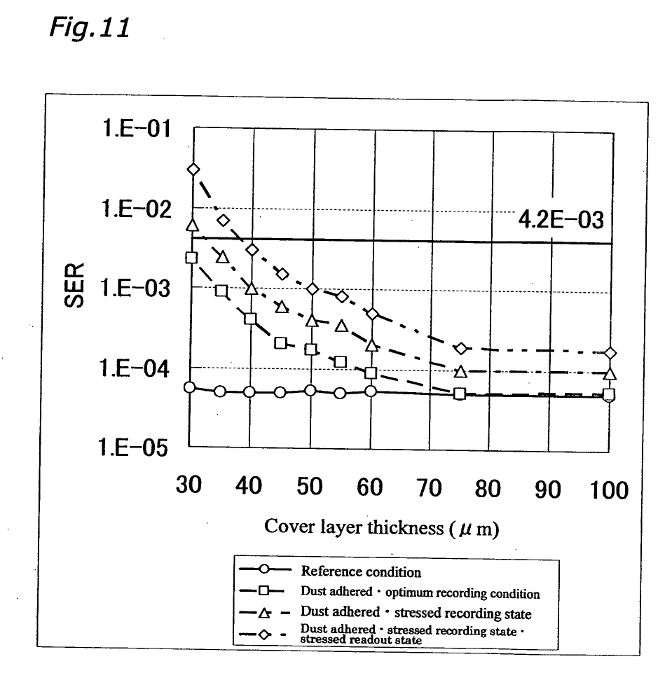

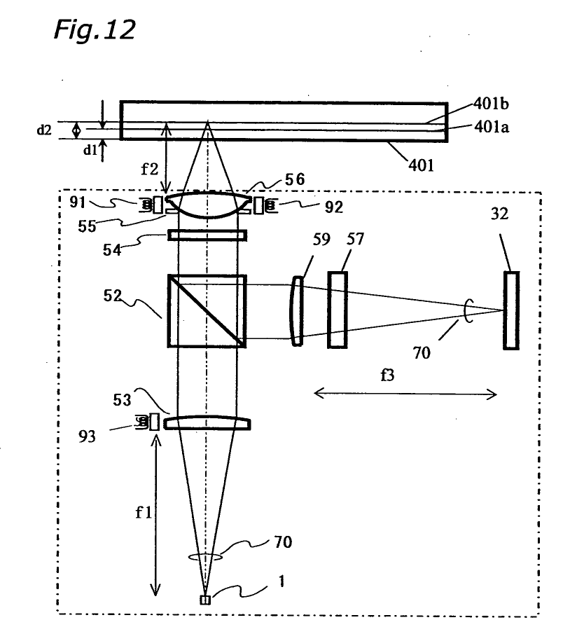

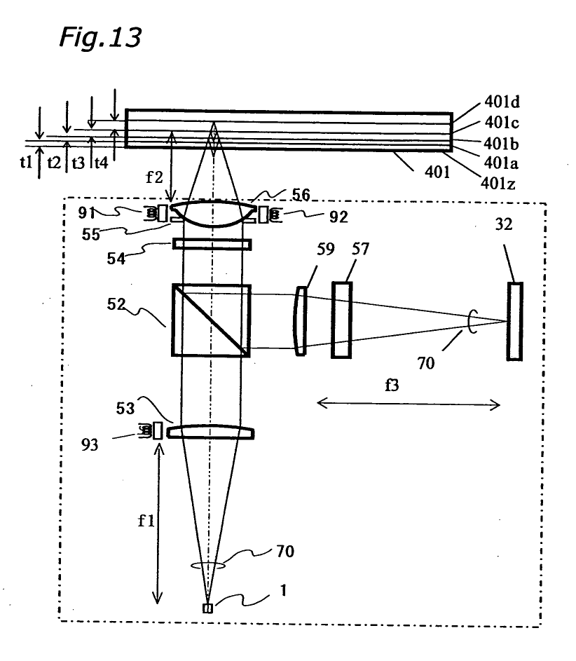

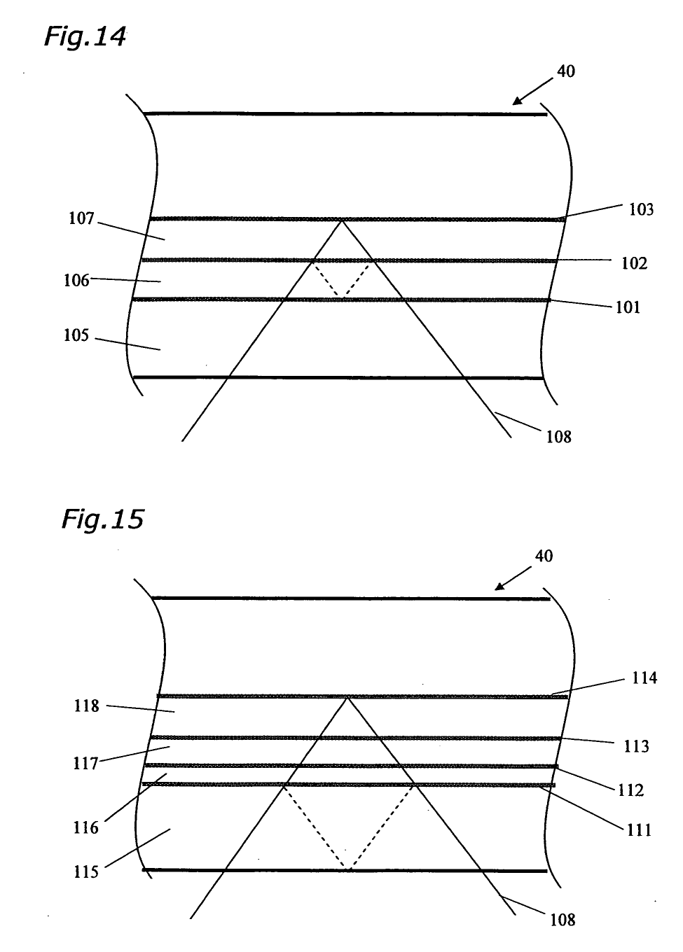

FIG. 11 shows evaluation results of the error rate of disks that varied in the thickness of their cover layers from 100 to 30 μm. These disk samples were either with or without flaws formed on the surfaces of their cover layers. Randomly patterned signals, which were modulated by 1-7PP modulation and had a reference clock frequency of 66 MHz and a shortest mark length of 149 nm, are recorded on the disk samples. The linear speed at which signals were recorded or reproduced was set at 4.9 m/sec. The disk samples with flaws on their cover layer surfaces specifically had dust with a diameter of 20 μm or less adhered on the cover layer surfaces to occupy about 1% of the entire surface areas of the disk samples (with a dust area ratio of about 1%). The state of the cover layer surfaces with such dust was similar to the state of the cover layer surfaces possible in a typical household environment.

These disk samples were evaluated in terms of their symbol error rate (SER). In the evaluation, disk samples with the SER of 4.2*10⁻³ or less were determined acceptable. This error rate value indicates the possibility that one out of one million disks can be a defective disk from which information may fail to be read. Disks with this error rate value or less are acceptable optical information recording media that have sufficiently high recording and reproduction performance. The same SER evaluation was conducted on the disk samples when recording signals, under an optimum recording condition, in a possible stressed recording state, and in a stressed reading state to determine whether the disk samples were acceptable or to be rejected. In the stressed recording state, the recording power of the disk samples was set 10% lower than the optimum recording power. The stressed recording state was set by evaluating various stress factors of disks and converting them to the power. The estimated stress factors included the amount of defocused recording and readout light, the effect of possible disk tilt, the amount of possible spherical aberration, possible errors in setting the recording power, possible errors in learning the recording power to optimize the recording power, and possible errors in setting the recording power associated with temperature changed. In the stressed readout state, the recording power of the disk samples was set 30% lower than the normal readout power. The stressed readout state was set by evaluating various stress factors of disks and converting them to the power. The estimated stress factors included possible manufacturing errors of the optical head used for readout, the amount of defocused light, and displacement of tracks caused by possible disk tilt.

The disk samples that varied in the thickness of their cover layers from 100 to 30 μm without dust on the cover layer surfaces were subjected to recording and readout performed under a reference condition. More specifically, the samples without dust on the cover layer surfaces were subjected to recording performed under the optimum recording condition and readout performed with the normal reproduction power. The SER values of these samples were used as reference values. The samples that varied in the thickness of their cover layers from 100 to 30 μm with dust on the cover layer surfaces were subjected to recording performed under the optimum recording condition, recording performed in the stressed recording state, and readout performed in the stressed readout state. The SER values of the samples under the reference condition and the SER values of the samples under the optimum recording condition, in the stressed recording state, and in the stressed readout state were evaluated. FIG. 11 shows the evaluation results. As shown in FIG. 11, the SER values of the samples did not exceed 4.2*10⁻³ in any of the dust adhered state, the stressed recording state, and the stressed readout state when the thickness of the cover layer of each sample was 38 μm or greater. This indicates that the thickness of the cover layer is only required to be 38 μm or greater.

TABLE 1

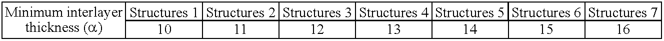

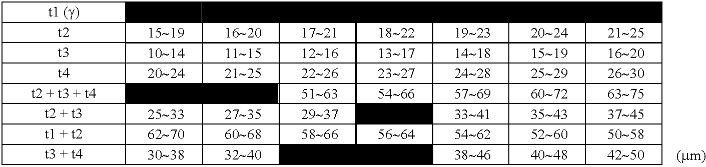

TABLE 2

| Minimum interlayer | Structures 8 | |
|---|---|---|
| thickness (α) | 11 | |
| t1 (γ) | 43˜47 | |
| t2 | 16˜20 | |
| t3 | 11˜15 | |
| t4 | 22˜26 | |
| t2 + t3 + t4 | 49˜63 | |
| t2 + t3 | 27˜35 | |
| t1 + t2 | 57˜67 | |
| t3 + t4 | 33˜41 | (μm) |

Table 1 shows the structures of comparative examples of the present invention. The structures uniformly have the minimum interlayer thickness dmin of 10 μm or greater, the manufacturing errors of their cover layers and intermediate layers of ±2 μM or greater, and the thickness difference between the intermediate layers of 1 μm. The structures vary in the thicknesses of their cover layers and intermediate layers. In Table 1, structures 5, 6, and 7 have the cover layer thickness of 38 μm or less (indicated by shaded areas) and therefore are not acceptable. Structures 1 to 4 have thicknesses that fail to satisfy some of conditions 1 to 4 described above (indicated by shaded areas).

To obtain an acceptable structure, structure 2 is changed to structure 8 shown in Table 2 by changing the thickness t1 of its cover layer and the thickness t4 of its third intermediate layer. The structure shown in Table 2 is within the thickness ranges specified in the embodiment of the present invention. Changing the structures to have the thickness t1 in a range of 43 to 47 μm, the thickness t2 in a range of 16 to 20 μm, the thickness t3 in a range of 11 to 15 μm, and the thickness t4 in a range of 22 to 26 μm will solve the problems described above.

The optical recording medium having four information recording surfaces that are formed using any combination of these value ranges reduces interference with light reflected from a specific signal surface from which information is to be read. As a result, the present invention provides a large-capacity optical recording medium that has stable servo signals and readout signal.

The above combined value ranges are mere examples. Any structure formed using values close to the above ranges will have the same advantages as described above.

Although the present invention is described based on the preferred embodiment, the present invention should not be limited to the embodiment described above but may be changed without departing from the scope of the invention.

For example, the optical information apparatus of the present invention may be an apparatus that performs both recording and reproduction, an apparatus that performs only recording, or an apparatus that performs only reproduction.

The multilayer optical disk of the present invention minimizes interference of light reflected from layers other than a specific layer during reproduction on the specific layer, and prevents the optical head from causing such interference of light to affect servo signals and readout signals. Therefore, the present invention provides a large-capacity optical disk that has high-quality readout signals and is readily compatible with the existing disks.

This application claims priority to Japanese Patent Application No. 2006-276498. The entire disclosure of Japanese Patent Application No. 2006-276498 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. An optical recording medium having at least three information recording surfaces, wherein
d1<(dm−d1), where d1 is a distance from a surface of the optical recording medium to one of the at least three information recording surfaces that is nearest to the surface of the optical recording medium and dm is a distance from the surface of the optical recording medium to one of the at least three information recording surfaces that is most distant from the surface of the optical recording medium, and
dmin≧8 μm, where dmin is a minimum interlayer thickness between the at least three information recording surfaces.

2. The optical recording medium according to claim 1, wherein
dmin≧10 μm.

3. The optical recording medium according to claim 1, wherein
d1 is smaller than (dm−d1) by at least 1 μm.

4. The optical recording medium according to claim 1, wherein
d1≧38 μm.

5. The optical recording medium according to claim 1, wherein
d1≦47 μm.

6. The optical recording medium according to claim 1, wherein
one of the at least three information recording surfaces that is the third nearest to the surface of the optical recording medium or one of the at least three information recording surfaces that is more distant from the surface of the optical recording medium than the third nearest information recording surface is at a distance of 100 nm from the surface of the optical recording medium.

7. The optical recording medium according to claim 6, wherein
the at least three information recording surfaces consist of four information recording surfaces.

8. The optical recording medium according to claim 7, wherein
one of the four information recording surfaces that is the fourth nearest to the surface of the optical recording medium is at a distance of 100 μm from the surface of the optical recording medium.

9. An optical recording medium having four information recording surfaces, wherein
the four information recording surfaces consist of a first information recording surface, a second information recording surface, a third information recording surface, and a fourth information recording surface that are arranged sequentially in a stated order from a surface side of the optical recording medium,
the first information recording surface is at a distance of 47 μm or less from a surface of the optical recording medium,
a thickness of an intermediate layer arranged between the first information recording surface and the second information recording surface falls within one of a range of 11 to 15 μm, a range of 16 to 21 μm, and a range of 22 μm or greater, a thickness of an intermediate layer arranged between the second information recording surface and the third information recording surface falls within another one of the ranges, and a thickness of an intermediate layer arranged between the third information recording surface and the fourth information recording surface falls within still another one of the ranges, and
the fourth information recording surface is at a distance of 100 μm from the surface of the optical recording medium.

10. The optical recording medium according to claim 1, wherein
recording or reproducing is performed on the optical recording medium using an optical head with a wavelength of 405 nm that includes an objective lens with a numerical aperture NA of substantially 0.85.

11. An information recording or reproducing method for the optical recording medium according to claim 1, wherein
information recording and/or information reproducing is performed using an optical head that includes an aberration correction unit for correcting an aberration that is generated according to a thickness of a cover layer of the optical recording medium.

12. An information recording or reproducing apparatus for the optical recording medium according to claim 1, the apparatus comprising:
an optical head for illuminating the optical recording medium with light and focusing the light onto a desired information recording surface of the optical recording medium;
a control unit for controlling the optical head;
a rotation unit for rotating the optical recording medium; and
a recording or reproducing unit for performing information recording and/or information reproducing on the optical recording medium.

13. The information recording or reproducing apparatus according to claim 12, wherein
the optical head includes a spherical aberration correction unit for diverging or converging the light illuminating the optical recording medium according to an information recording surface on which recording or reproducing is performed.

14. The optical recording medium according to claim 2, wherein
d1 is smaller than (dm−d1) by at least 1 μm.

15. The optical recording medium according to claim 2, wherein
d1≧38 μm.

16. The optical recording medium according to claim 3, wherein
d1≧38 μm.

17. The optical recording medium according to claim 2, wherein
d1≦47 μm.

18. The optical recording medium according to claim 3, wherein
d1≦47 cm.

19. The optical recording medium according to claim 4, wherein
d1≦47 μm.
